(19) United States
(12) Patent Application Publication
(10) Pub. No.: US 2017/0167606 A1
(43) Pub. Date: Jun. 15, 2017

(54) Remotely Tunable Continuously Variable Transmission and Control Method Thereof

(71) Applicant: Joseph Nicholas Kochevar, Carmel Valley, CA (US)

(72) Inventor: Joseph Nicholas Kochevar, Carmel Valley, CA (US)

(73) Assignee: Joseph Nicholas Kochevar, Carmel Valley, CA (US)

(21) Appl. No.: 14/965,379

(22) Filed: Dec. 10, 2015

(51) Int. Cl. F16H 61/662; G07C 5/00; G05B 15/02; F16H 9/14

(52) U.S. Cl. CPC F16H 61/66236; F16H 9/14; G07C 5/008; G05B 15/02; F16H 2342/02

(57) ABSTRACT

The remotely tunable CVT is an apparatus that comprises a continuously variable transmission, in which an actual speed ratio is feedback-controlled to a target speed ratio, in addition to a communications system configured to enable wireless communication with an external computer, and a control system configured to allow the target speed ratio to be controlled via the aforementioned external device. A corresponding method is also disclosed.

### BACKGROUND

This disclosure relates generally to continuously variable transmissions (CVTs), and more particularly to off-road vehicle CVTs.

CVTs are generally known. The CVT has features including linking two shafts with a variable gear ratio, permitting a gradient, rather than a set of fixed gear ratios. However, in simplified systems as often seen on off-road vehicles, CVTs often need to be adjusted for different uses and desired behaviors, which often requires a partial disassembly of the drivetrain, and a stop in driving.

It would be useful to improve this shifting mechanism to facilitate a more versatile tuning adjustment system that does not require drivetrain disassembly, or even a stop of the engine.

### SUMMARY

One embodiment described herein is an apparatus that comprises a continuously variable transmission, in which an actual speed ratio is feedback-controlled to a target speed ratio, in addition to a communications system configured to enable wireless communication with an external computer, and a control system configured to allow the target speed ratio to be controlled via the aforementioned external device.

Another embodiment described herein is control method that includes gathering rotational speed data of a primary pulley in a vehicle transmission, retrieving target speed data from an external computer through a wireless connection, and feedback-controlling the primary pulley in the vehicle transmission based upon the ratio between target and measured rotational speeds.

### BRIEF DESCRIPTION OF THE DRAWINGS

FIG. 1 shows a system diagram for a first embodiment of a remotely tunable CVT.

FIG. 2 shows a side view of one embodiment of a motorized vehicle-mounted continuously variable transmission (hereinafter, referred to as “CVT”).

FIG. 3 shows an isometric view of the motorized vehicle-mounted CVT shown in FIG. 2.

FIG. 4 shows the main CVT controlling system of one embodiment, including a primary pulley.

FIG. 5 shows an embodiment of the system that includes a smartphone or other computer connecting wirelessly to a primary CVT.

FIG. 6 shows a graph depicting the ideal shifting cycle of a standard CVT.

### DETAILED DESCRIPTION

The primary pulley of the CVT has an internal measurement system for measuring rotational speeds, a CVI control unit for interpreting these speeds and controlling the unit accordingly, and an extern& communication system for communicating with an external system in order to change the CVT Control. External to the system exists a computer system that relays information to the main CVI unit remotely.

Definitions:

As used herein, the term “communications system” means computer hardware and computer software that transmits data between the CVT control system and an external computer system in any wireless method, including but not limited to: Bluetooth, Wi-Fi, and radio transmission.

As used herein, the term “control system” means computer hardware and software that adjusts the speed ratio of the transmission in response to data received from the internal measurement system as well as data received from the external communication system.

As used herein, the term “computer” means any hardware and software capable of accepting, processing, and outputting data.

As used herein, the term “internal measurement system” means any hardware and software for measuring or recording rotational speed information.

The system includes a plurality of pulleys. The primary and secondary pulleys have grooves that are aligned so that a belt can pass between. The primary pulley is mounted coaxially with an engine, while the secondary pulley is mounted coaxially to a shaft of the final drive system.

The rotation of the primary pulley is transmitted to the secondary pulley via the belt, and the rotation of the secondary pulley is transmitted to a final drive system, comprising an output shaft, a gear set and a differential gear device.

To make a speed ratio between the primary pulley and the secondary pulley changeable during the above power transmission, one of the conical plates forming the groove of each of the primary pulley and the secondary pulley is a fixed conical plate, while the other conical plate is movable in an axial direction. This effectively controls both pulley diameters, thereby changing the ratio of their speeds.

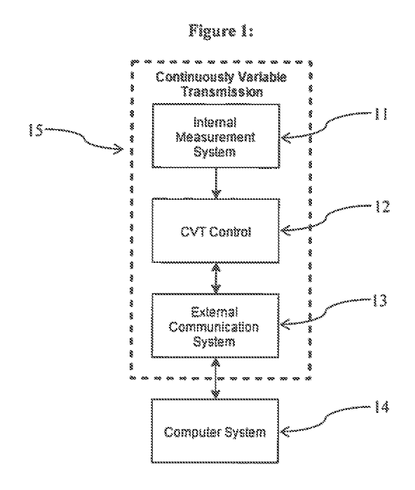

FIG. 1 shows an embodiment of a system generally designated as 10, wherein the main unit of the CVT 15 has an internal measurement system 11 for measuring rotational speeds, a CVT control unit 12 for interpreting these speeds and controlling the unit accordingly, and an external communication system 13 for communicating with an external system in order to change the CVT control External to the system exists a computer system 14 that relays information to the main CVT unit remotely through the external communication system 13. As shown in FIG. 1, it is possible to control the CVT using rotational speed information from an internal measurement system. The CVT control receives a target speed from the external communication system, and manipulates the CVT pulley by changing the ratio of the speed from the internal measurement system and the speed from the external communication system. This ratio is changed via a mechanical linkage that decreases the axial distance between the conical plates of the primary pulley.

By linking the CVT to an external communication system, it is therefore effectively possible to control the target speed of the primary CVT externally without stopping the CVT from spinning. In one embodiment, the computer system is linked to a GPS system that allows the drive unit to “shift” based upon vehicle location or speed, without necessitating a complete overhaul of an existing system.

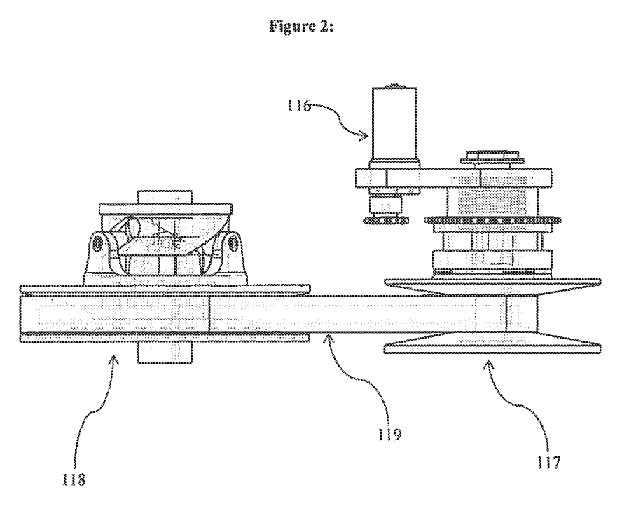

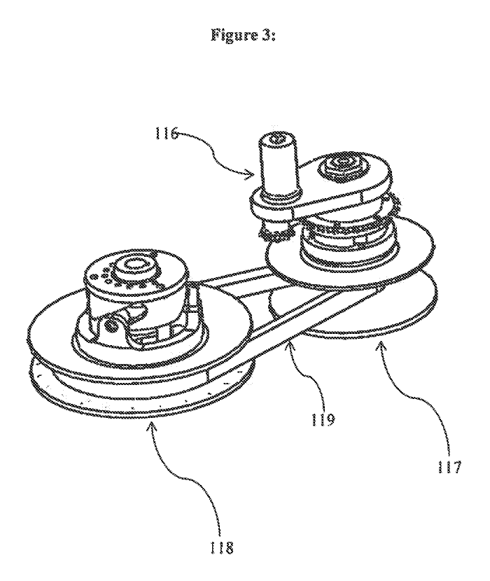

FIGS. 2-3 show an embodiment of a remotely tunable CVT that is generally designated as 110. The CVT includes a driving pulley 117 and secondary pulley 118, connected by the belt 119. It also shows control system 116, which includes or is connected to an internal measurement system and external communication system. The internal measurement system and external communication system may also be separate from the control system in a separate embodiment.

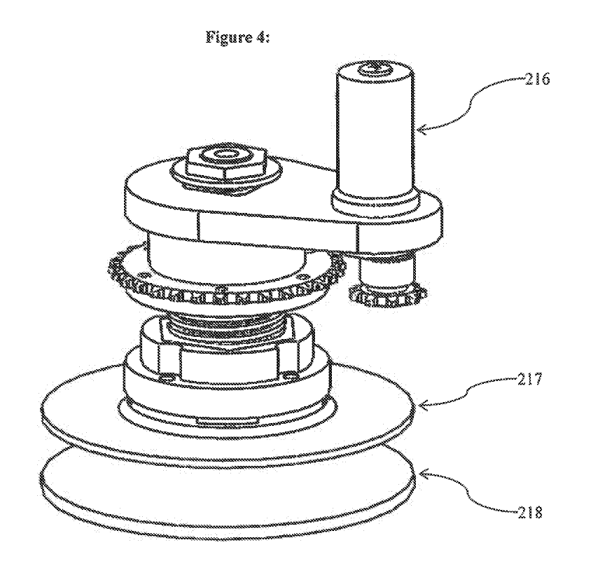

FIG. 4 shows an embodiment of the primary pulley for a remotely tunable CVT that is generally designated as 210. This unit also shows the CVT control system 216 that encompasses the communication and control units. It also shows the two conical plates 217 and 218, which control the effective pulley diameter and therefore the overall speed ratio between the two pulleys.

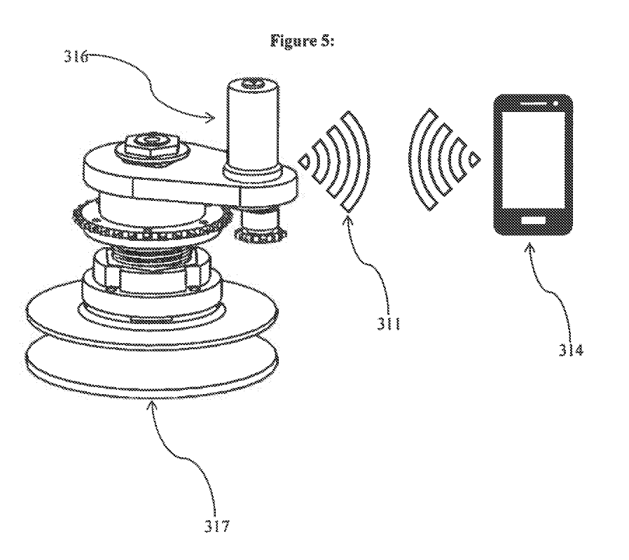

FIG. 5 shows an embodiment of a remotely tunable CVT, portraying just the primary pulley 317 with attached control system 316 in communication with an external computer 314. In this embodiment, the connection 311 is depicted as a general wireless connection. One possible reason for this orientation is to link GPS information from the external computer to a designated shifting pattern or set of ratios that would be communicated to the control system 316. This would effectively automate the shifting of the CVT based upon predetermined GPS waypoints.

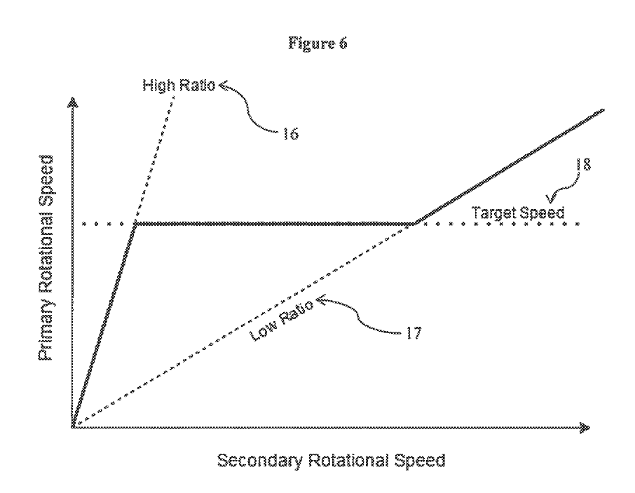

FIG. 6 shows an ideal graph of a standard CVT shifting cycle, where the High Ratio 16 depicts the initial ratio of the two pulleys, and the Low Ratio 17 is the final ratio of the two pulleys. The CVT ideally stays at the high ratio until a Target Speed 18 is reached. At that point, the CVT shifts in order to keep primary rotational speed as close to the target speed as possible until reaching the high ratio, where the CVT can no longer continue to shift. The target speed is usually set to a specific rotational speed depending upon the engine, and is used to achieve desired performance goals. Possible performance goals include but are not limited to maximum power, maximum torque, and peak efficiency. The goal of the proposed system is to allow for the target speed to be adjusted during normal operation by interfacing with a separate computer.

The apparatus and method described herein is particularly useful for terrain vehicles, including but not limited to all-terrain vehicles and SAE Baja competition vehicles. Many automobiles facilitate the in-operation shifting of target speeds using onboard computers. The proposed invention avoids the complexities of mounting and programming these systems to interface with existing vehicular systems, and potentially allows for the simple swap of CVT pulleys in order to achieve similar aims. This would avow for increased transmission performance on a variety of vehicular platforms.

What is claimed is:

1. An apparatus comprising:
a continuously variable transmission in which an actual speed ratio is feedback-controlled to a target speed ratio,
a communications system configured to enable wireless communication with an external computer, and
a control system configured to allow the target speed ratio to be controlled via the external computer.

2. The apparatus of claim 1, wherein the control system is formed on the continuously variable transmission.

3. The apparatus of claim 1, wherein the control system is formed on the external computer.

4. The apparatus of claim 1, wherein the control system includes a first portion formed on the continuously variable transmission and a second portion formed on the external computer.

5. The apparatus of claim 1, wherein the continuously variable transmission includes an internal measurement system configured to measure rotational speeds.

6. A control method comprising:
gathering rotational speed data of a primary pulley in a vehicle transmission, retrieving target speed data from an external computer through a wireless connection,
feedback-controlling the primary pulley in the vehicle transmission based upon the ratio between target and measured rotational speeds.

7. The control method of claim 6, wherein feedback controlling the primary pulley comprises changing the speed ratio of the two pulleys by adjusting the axial distance between the two conical plates of the primary pulley.
